(19) United States
(12) Patent Application Publication
(10) Pub. No.: US 2004/0211278 A1
(43) Pub. Date: Oct. 28, 2004

(54) Load sharing gear for high torque, split-path transmissions

(76) Inventors: Yuriy Gmirya, Woodbridge, CT (US); Harsh Vinayak, Meriden, CT (US)

Correspondence Address: Sikorsky Aircraft Corporation, Legal-IP Department , MS 316A, 6900 Main Street, P.O. Box 9729, Stratford, CT, 06615-9129, US

(21) Appl. No.: 10/421,619

(22) Filed: Apr. 23, 2003

(51) Int. Cl. F16H 55/18

(52) U.S. Cl. 74/410; 74/409

(57) ABSTRACT

A gear adapted to provide load sharing in a torque split transmission module wherein at least one spring element is disposed in combination with a torque driving shaft at one end thereof and in combination with a ring of torque transmitting gear teeth at the other end thereof. The spring element is radially stiff to center the ring of gear teeth about the shaft and is torsionally soft to permit relative rotational displacement between the gear teeth and the shaft.

The spring element is substantially disc shaped and includes a plurality of recurved radial spokes. More specifically, the spokes project radially outboard from a first mounting ring, define a 180 degree bend proximal to the gear teeth, and extend inwardly toward a second mounting ring. A pair of spring elements may be used wherein the first mounting ring of each spring element connects to shaft flange and the second mounting ring mounts to an inboard end of a radial flange of the gear teeth. Furthermore, each of the pair of spring elements is disposed on either side of the radial flange to balance the spring force about a medial plane defined by the ring of gear teeth.

A manufacturing method for fabricating the spring element is also disclosed.

### TECHNICAL FIELD

This invention relates to transmissions having a split load path for reducing gear tooth loading, and more particularly, to a new and useful gear which effects load sharing in a split torque transmission module.

### BACKGROUND OF THE INVENTION

A transmission system comprises one or more independent gear trains or branches composed of intermeshing gears and is operative to couple the power (torque) developed by a power plant system to an output member. In those applications where the power plant system comprises two or more engines, the transmission system includes an independent gear train or branch for coupling the torque developed by each engine to the output member, e.g., the transmission system for a two-engine power plant system would comprise two independent gear trains or branches. In such transmission systems, and in particular, helicopter transmission systems, it may be desirable to split the power output from each engine of the power plant system so that each associated gear train or branch includes redundant, i.e., split, load paths for coupling the power from the corresponding engine to a common output member, e.g., the main rotor shaft of a helicopter. This portion of the gear train is commonly referred to as the torque split transmission module. Such split path transmission modules reduce the tooth loading of the intermeshing gears, i.e., gear train assemblies, comprising each redundant load path and result in lighter weight gear train assemblies. In addition, split path transmission modules are inherently more reliable from the perspective that if one gear assembly, i.e., load path, becomes inoperative, the total torque from the respective engine will be transmitted through the remaining gear assembly, i.e., the redundant load path, thereby ensuring short-term emergency operation of the transmission system.

Ideally, a torque split transmission module should be designed to ensure that torque is split in equal proportions between the load paths of each torque transmitting branch. One skilled in the art will also recognize that by simply driving torque from a singular input gear to dual output gears does not by itself ensure that the torque will be equally distributed in an ideal manner between the output gears. The torque split, i.e., load sharing, between the split load paths of the respective torque transmitting branches will be a natural result or consequence of the relative gear tooth Hertzian deflections, gear tooth bending deflections, gear rim deflections, torsion and bowing of gear shafts, bearing deflections, and by housing deflections due to loading/thermal effects. These factors, individually or in combination, can cause torque loading differentials within the torque split transmission module.

In an attempt to minimize torque load differences between the split load paths of the module, the prior art has interposed a torque adjusting device within the torque load path between the engine and the central bull gear. One prior art torque adjusting device for split path transmission systems is a quill shaft as exemplarily illustrated in FIG. 3 of U.S. Pat. No. 5,113,713. Quill shafts provide a means for minimizing the torque loading differences between the split load paths by reducing the torsional spring rates of the load paths, which reduces the net effects of the factors that produce torque load differentials. While the use of quill shafts to reduce torsional spring rates is a relatively effective method, the method does not completely compensate for the factors causing the torque loading differences, but instead acts to minimize the net effect of such factors. Therefore, the quill shaft method does not guarantee, and rarely achieves, the ideal condition of an equal distribution of torque between the forward and aft split load paths. Furthermore, incorporating a quill shaft in each gear train assembly increases the overall complexity and weight of the split path transmission system. This, in turn, increases the costs and time required for initial assemblage and subsequent maintenance of the transmission system. In addition, incorporation of quill shafts into the transmission system reduces the reliability of the system such that inspection and maintenance is required on a more frequent basis.

Yet another means to effect load sharing is disclosed in U.S. Pat. No. 5,117,704 entitled “Elastomeric Torsional Isolator” wherein a ring of elastomer is interposed between the web and teeth of a spur gear. The elastomer, which is preloaded by means of a V-shaped bearing race, is soft in the tangential direction thereby permitting a small degree of wind-up of the gear teeth relative to the gear shaft. Two such load sharing gears are incorporated in the torque split transmission module, typically between the input pinion and each output pinion which drives the main bull gear. Wind-up of the gear teeth compensates for many of the factors which typically cause torque load differences. While this approach produces the desired load sharing effect, elastomer materials can degrade over time, especially when exposed to oils and elevated temperature as are always present in most high torque transmissions. Furthermore, this configuration adversely impacts the cost and weight of the transmission system.

A need, therefore, exists to provide a load sharing gear in a torque split transmission module that is operative to provide substantially equal torque distribution therein. Such a split load sharing gear and torque split transmission module should achieve equal torque distribution without adversely impacting the weight, manufacturability, cost or complexity of the torque split transmission module.

### DISCLOSURE OF THE INVENTION

It is the object of the present invention to provide a load sharing gear for use in a torque split transmission module which provides substantially equal torque distribution.

It is another object of the present invention to provide such load sharing gear which reduces the weight and complexity of the torque split transmission module.

It is yet another object of the present invention to provide such a load sharing gear which may be readily adapted for use in existing transmission module assemblies.

It is still a further object of the present invention to provide such a load sharing gear which may be fabricated utilizing conventional, low-cost manufacturing methods.

These and other objects of the present invention are achieved by a gear adapted to provide load sharing in a torque split transmission module wherein at least one spring element is disposed in combination with a torque driving shaft and a ring of torque transmitting gear teeth. The spring element is radially stiff to center the ring of gear teeth about the shaft and is torsionally soft to permit relative rotational displacement between the gear teeth and the shaft.

The spring element is substantially disc shaped and includes a plurality of recurved radial spokes. More specifically, the spokes project radially outboard from a first mounting ring, define a 180 degree bend proximal to the gear teeth, and extend inwardly toward a second mounting ring. Moreover, a pair of spring elements may be used wherein the first mounting ring of each spring element connects to shaft flange and the second mounting ring mounts to an inboard end of a radial flange of the gear teeth. Furthermore, each of the pair of spring elements is disposed on either side of the radial flange to balance the spring force about a medial plane defined by the ring of gear teeth.

The spring element may be manufactured by: forming a pair of discs having a predefined thickness, machining each disc to form a peripheral ring projecting orthogonally from a side of the disc, welding the peripheral rings of each together thereby forming a thin diaphragm structure, and removing material from each side of the diaphragm structure to form the recurved radial spokes. The step to form the radial spokes may be performed by Wire Electro-Discharge Machining (Wire EDM), abrasive waterjet machining, Electro-Chemical Machining (ECM), High Speed Machining or conventional grinding (i.e., Milling).

### BRIEF DESCRIPTION OF THE DRAWINGS

A more complete understanding of the present invention and the attendant features and advantages thereof may be had by reference to the following detailed description when considered in conjunction with the accompanying drawings wherein:

FIG. 1 is a perspective view of an exemplary embodiment of a helicopter drive train employing a torque split transmission module.

FIG. 2 is a bottom view along line 2-2 of FIG. 1 of the torque split transmission module.

FIG. 3a is an isolated perspective view of the load sharing gear according to the present invention disposed in combination with a double helical pinion of the torque split transmission module.

FIG. 3b is an exploded view of the load sharing gear and double helical pinion of FIG. 3a.

FIG. 4 is an isolated perspective view of a spring element employed in the load sharing gear of the present invention.

FIG. 5a is a cross-sectional view taken substantially along line 5a-5a of FIG. 3a.

FIG. 5b is a cross-sectional view taken substantially along line 5b-5b of FIG. 3a.

FIGS. 6a-6d schematically show various manufacturing steps for fabricating one of the spring elements in the load sharing gear.

### BEST MODES FOR CARRYING OUT THE INVENTION

The load sharing gear and torque split transmission module of the present invention are described in the context of a helicopter transmission, such as that employed in the RAH-66 Comanche helicopter being developed by the Sikorsky Aircraft Corporation. One skilled in the art will appreciate that the present invention has utility in torque split transmission modules for helicopters having other power plant system configurations, e.g., a power plant system composed of one engine or three engines, as well as for applications other than helicopter transmission systems. Furthermore, while the inventive load sharing gear is described in the context of a spur gear, one will readily appreciate that the inventive teachings are equally applicable to other types of gears, for example, a double helical gear. Therefore, it is to be understood that the following description of the load sharing gear and torque split transmission module of the present invention is not intended to be limiting, but merely illustrative of the teachings according to the present invention.

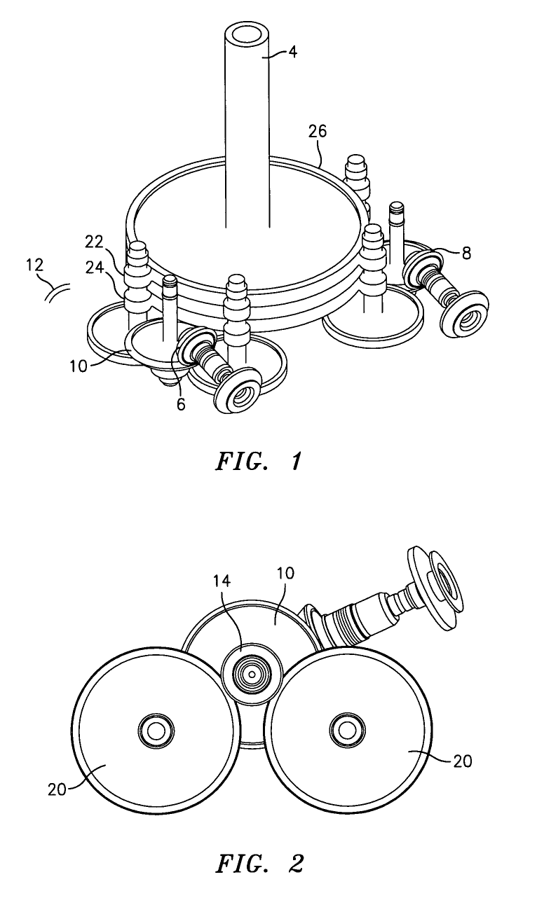

In FIG. 1, a helicopter drive train is shown wherein the outer casing or gearbox housing has been omitted to view the various internal drive train components and their interaction. The helicopter drive train 2 is designed to effect a reduction in the range of 70:1 from the engine drive shaft (not shown) to the main rotor shaft 4. This speed reduction occurs in three stages which will become apparent in view of the subsequent detailed description. Two engines (not shown) drive first and second input bevel pinions 6 and 8, respectively. Inasmuch as the subsequent drive train components driven by each of the input bevel pinions 6, 8 are identical, only one drive path, i.e., associated with the first input bevel pinion 6 will be described.

The input bevel pinion 6 drives a first stage bevel gear 10 which, in turn, drives a torque split transmission module 12. The torque split transmission module (best seen by reference to FIG. 2) comprises a second stage spur pinion 14 disposed between a pair of load share spur gears 20, according to the present invention. That is, the teachings of the present invention are illustrated and applied to each of the spur gears 20. More specifically, the first stage bevel gear 10 is coaxial with and drives the second stage spur gear 14 which is disposed between and drives each of the load share gears 20. Each of these load share gears 20 are co-axial with and drive second stage double helical pinions 22, 24. Each of the helical pinions 22, 24 drives a large diameter double helical bull gear 26 which, in turn, drives the main rotor shaft 4. Inasmuch as the torque loading transmitted through the second stage gears 20 and helical pinion 22, 24 are extremely high, i.e., on the order of between 800-900 ft-lbs, it is desirable to split the load equally by the torque split transmission module 12.

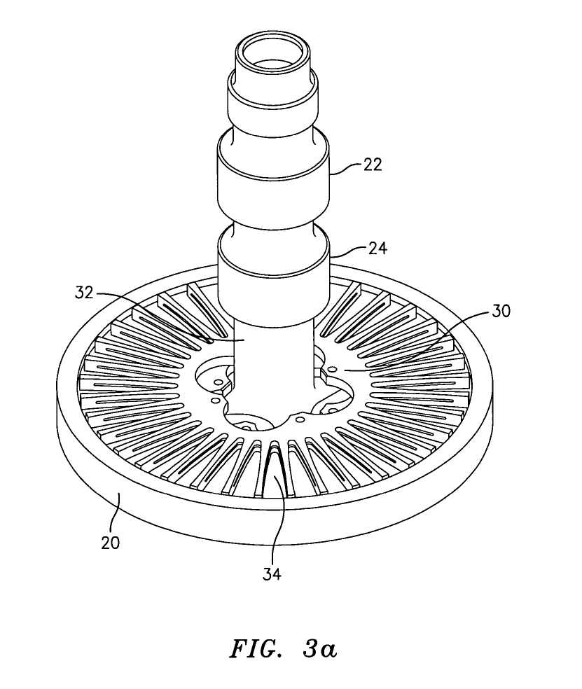

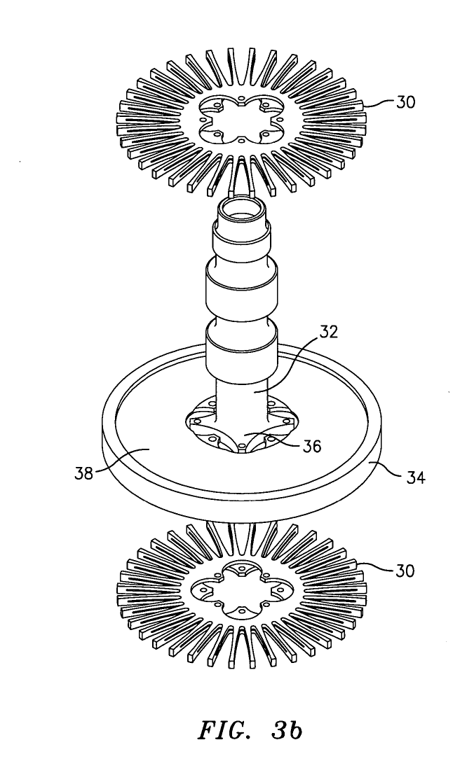

Before discussing the functional and/or operational advantages of each load share spur gear 20 of the present invention, the various structural features thereof will be described. FIG. 3a shows an isolated perspective view of a single load share spur gear 20 and, in FIG. 3b, an exploded view of the same is shown. While the double helical pinion 22, 24 is shown in combination with the load share gear 20, it will be appreciated that other gears or pinions may be driven by the load share gear 20 and/or employed in a torque split transmission module without departing from the spirit and scope of the invention.

Referring to FIGS. 3a and 3b, the load share gear 20 is characterized by at least one spring element 30 disposed between and structurally connecting the gear shaft 32 and the outer ring of gear teeth 34. The gear shaft 32 has flange elements 36 (four being shown in the preferred embodiment) projecting radially outboard of the shaft 32. The ring of gear teeth 34, similarly, has a flange element 38 projecting radially inward toward the gear shaft 32. In the preferred embodiment a pair of spring elements 30 are disposed on each side of the gear teeth flange element 38. That is, the ring of gear teeth defines a medial plane P, and a spring element is disposed on either side thereof.

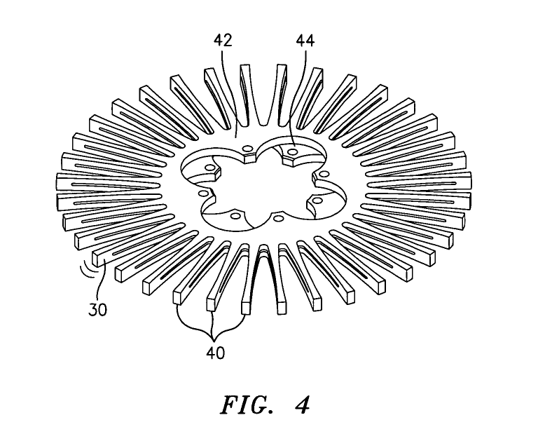

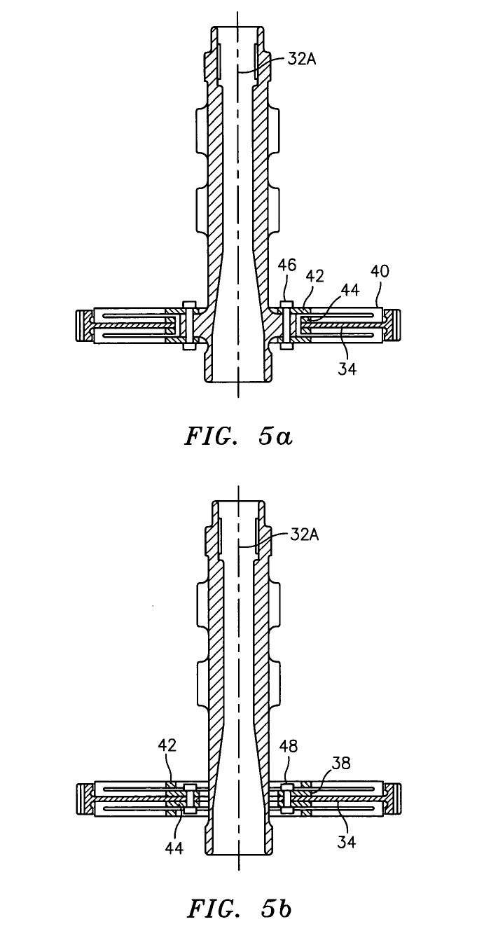

Referring to FIGS. 4, 5a and 5b, the spring element 30 is substantially disc shaped, and is characterized by a plurality of spokes 40 extending radially from and connecting to the shaft 32 at one end thereof, and connecting to the ring of gear teeth 34 at the other end thereof. Further, the spokes 40 are structurally interconnected, at each end thereof, by first and second mounting rings 42 and 44, respectively. Moreover, the spokes 40 extend radially outward from the first mounting ring 42, define a 180 degree bend (i.e., are recurved) proximal to the ring of gear teeth 34, and extend radially inward to the second mounting ring. In the preferred embodiment, the spokes are tapered in width dimension from an inboard to an outboard radial position. The first mounting ring 42 defines mounting apertures 46 to facilitate a through fastener (not shown) for engagement with the shaft flanges 36. Similarly, the second mounting ring 44 defines mounting apertures 48 for engagement of a fastener with the flange element 38 of the gear teeth 34. The mounting apertures 46, 48 are equally-spaced about the circumference their respective mounting rings 42, 44 and are staggered with respect to each other to facilitate assembly (i.e., such that the fasteners may be disposed at the same radial distance from the shaft 32). Moreover, the mounting apertures 46, 48, define a circular pattern wherein each lies an equal radial distance from the shaft axis 32A.

In the broadest sense of the invention, the spring elements 30 are radially stiff to rigidly center the gear teeth 34 about the shaft 32 while being torsionally-soft to permit relative rotational displacement between the gear teeth 34 and the shaft 32. In operation, the gear teeth 34 of one of the load share gears 20 may wind-up as a function of the torsional spring rate of the spring element 30. Inasmuch as the torque split module 12 defines a closed-loop load path (i.e., from the single second stage gear 14, to each load share gear 20, to each double helical pinion 22 and, finally, to the main double helical bull gear 26) the torsional loads of one of the load share gears 20 will be transmitted to the other, and visa-versa, upon reaching a threshold or equilibrium torque. As such the load will be equally shared or split between the two load share gears 20,

While each of the spokes 40 of the spring element 30 may extend as a single beam element from the shaft 32 to the gear teeth 34, it is preferable to recurve each of the spokes 40 to minimize or eliminate foreshortening effects. To better appreciate this phenomena, it should be understood that with increasing radius, each spoke 40 is subject to both radial and torsional displacement. That is, when envisioning an end of a spoke 40, it will be appreciated that in order to bend or deflect the spoke while maintaining a constant radius (assuming that an end of the spoke were attached to an outboard portion of the gear teeth flange 38), the spoke 40 must additionally elongate radially. Consequently, by recurving each spoke 40 such that each end of the spoke 40 essentially lies at the same radial position, i.e., from the shaft axis 34A, the spoke 40 is subjected to pure torsional or rotational motion. In view of the above description, it will be appreciated, therefore, that the flange 38, which extends radially inboard from the gear teeth 34, is disposed proximal to the shaft 32 and that the mounting apertures 46, 48 are staggered and lie at the same radial position relative to the shaft axis 32A. Stated yet another way, by locating the flanges 36, 38 at an inboard radial location, spoke deflections are minimized.

In the preferred embodiment, spring elements 30 are disposed on either side of gear teeth flange 38. While only one such spring element is essential to the invention, dual elements 30 ensure balance about the medial plane P defined by the ring of gear teeth 34.

The disc shape of each spring element 30 serves to minimize the design impact on the subject spur gear 20. That is, the spring element 30 has a low profile to minimize the impact on the design envelope. Furthermore, the spring element 30 may be readily adapted to any torque split transmission module employing similar gears for creating dual load paths. For example, the web of a typical spur gear could readily be redesigned so as to function as the radial flange element 38 of the gear teeth 34. Accordingly, a spring element 30 of the present invention, disposed between the shaft and the gear teeth 34, will provide the desired load sharing feature. Moreover, the spring element is remarkably low in weight and may be manufactured by conventional fabrication techniques, as will be described in subsequent paragraphs.

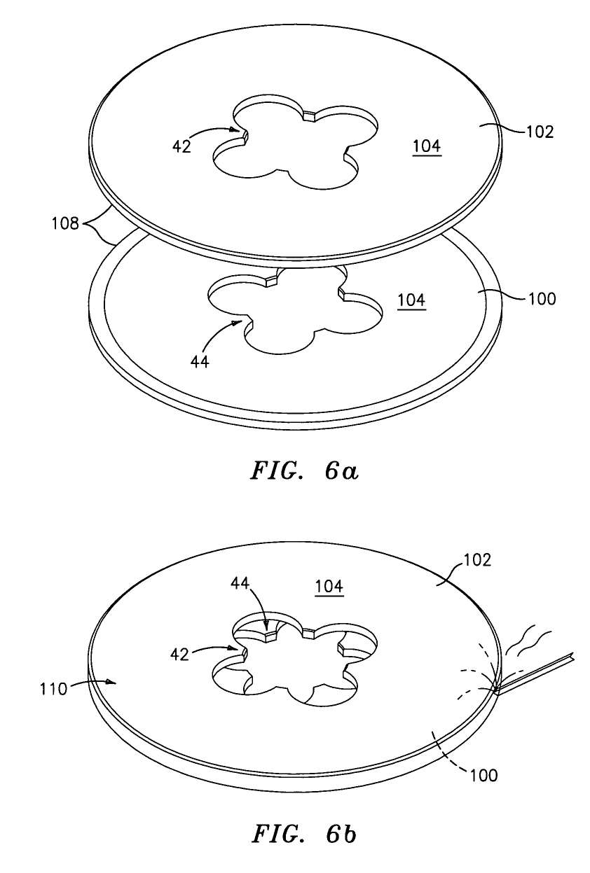

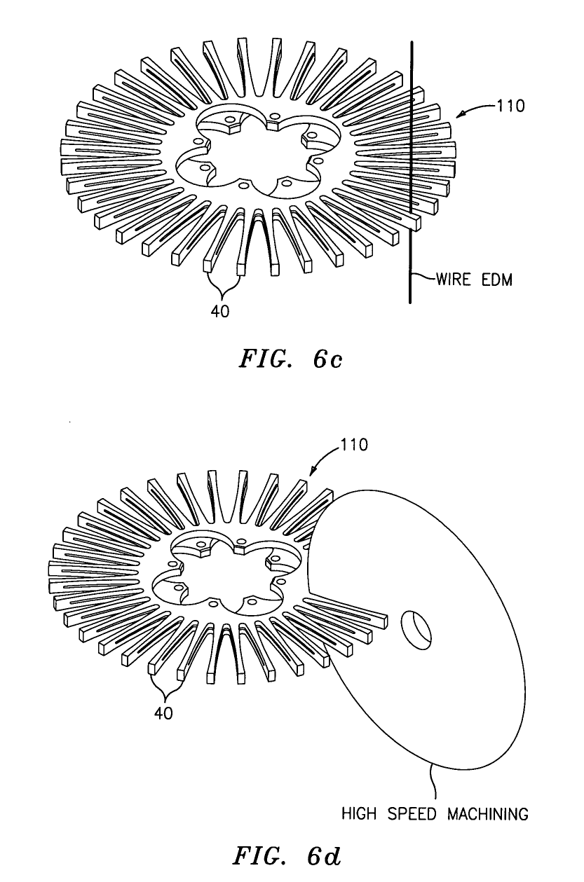

In FIGS. 6a-6d, various steps relating to the manufacture of the spring element 30 are illustrated. The spring element is fabricated by a combination of machining and welding operations. More specifically, the spring element 30 is fabricated by: a) forming a pair of discs 100, 102 having a predefined thickness, b) machining each of the discs 100, 102 to accurately define the face surfaces 104, mounting rings 42, 44, and, in addition, the formation of a peripheral ring 108 projecting orthogonally from a side of the disc, c) welding the peripheral rings of each together (see FIG. 6b) thereby forming a thin diaphragm structure 110, and d) cutting material from both sides of the diaphragm 110 to form the radial spokes 40 of the spring element 30.

In the preferred manufacturing process, the discs are machined by a conventional Numerically Controlled (NC) machine or, alternatively, by a high speed machining operation. The thickness remaining upon completion of the machining operation should equal the desired thickness of the spokes 40. When cutting material from both sides of the diaphragm, it is preferable to utilize Wire Electro-Discharge Machining (Wire EDM) (depicted in FIG. 6c), abrasive waterjet machining, Electro-Chemical Machining (ECM) or High Speed Machining (depicted in FIG. 6d). Inasmuch as the spokes 40 are symmetric, the machining operation may be performed from one side of the diaphragm to define the thickness and taper of the spokes 40.

While the foregoing disclosure of the present invention has been presented in terms of a split path transmission system having two independent gear trains, it will be appreciated that the method of the present invention is applicable to split path transmission systems composed of a single gear train or more than two independent gear trains, e.g., three independent gear trains.

Therefore, although the invention has been shown and described herein with respect to a certain detailed embodiment of a split path transmission system, it will be understood by those skilled in the art that a variety of modifications and variations are possible in light of the above teachings. It is therefore to be understood that, within the scope of the appended claims, the present invention may be practiced otherwise than as specifically described hereinabove.

What is claimed is:

1. A gear adapted to provide load sharing in a torque split transmission module, said gear having a shaft and a ring of torque-transmitting teeth, characterized by:
at least one spring element disposed in combination with said shaft at one end thereof and in combination with said ring of gear teeth at the other end thereof, said spring element being radially stiff to center said ring of gear teeth about said shaft and being torsionally soft to permit relative rotational displacement between said gear teeth and said shaft.

2. The gear according to claim 1 wherein said shaft and said gear teeth each include radial flanges and said spring element is further characterized by:
a plurality of radial spokes, said spokes connecting to said shaft flange at one end thereof and to said gear teeth flange at the other end thereof.

3. The gear according to claim 2 wherein said spring element is further characterized by:
first and second mounting rings formed with and integrally connecting the ends of said spokes.

4. The gear according to claim 3 wherein said gear teeth flange extends radially inward toward and proximal to said shaft and said spokes are recurved.

5. The gear according to claim 1 wherein said ring of gear teeth define a medial plane and being further characterized by:
a pair of spring elements disposed on either side of said medial plane.

6. The gear according to claim 5 wherein said shaft and said gear teeth each include radial flanges and each of said spring elements is further characterized by:
a plurality of radial spokes, said spokes connecting to said shaft flange at one end thereof and to said gear teeth flange at the other end thereof.

7. The gear according to claim 5 wherein each of said spring elements is further characterized by:
first and second mounting rings formed with and integrally connecting the ends of said spokes.

8. The gear according to claim 5 wherein said gear teeth flange extends radially inward toward and proximal to said shaft and said spokes of each spring element are recurved.

9. The gear according to claim 4 wherein each of said spokes define a width dimension and wherein said width dimension tapers from an inboard radial position to an outboard radial position.

10. The gear according to claim 8 wherein each of said spokes define a width dimension and wherein said width dimension tapers from an inboard radial position to an outboard radial position.

11. The gear according to claim 3 wherein said first and second mounting rings each define mounting apertures, said mounting apertures of said first mounting ring being staggered with respect to said mounting apertures of said second mounting ring, said mounting apertures being disposed at a common radial position to define a circular pattern.

12. The gear according to claim 7 wherein said first and second mounting rings each define mounting apertures, said mounting apertures of said first mounting ring being staggered with respect to said mounting apertures of said second mounting ring, said mounting apertures being disposed at a common radial position to define a circular pattern.

13. A spring element for use in a load share gear, said gear being adapted to provide load sharing in a torque split transmission module, said spring element being characterized by:
a plurality of radial spokes; and
first and second mounting rings formed with and integrally connecting the ends of said spokes;
said spokes projecting radially outboard from said first mounting ring and being recurved for extending inwardly toward said second mounting ring.

14. The spring element according to claim 13 wherein said first and second mounting rings each define mounting apertures, said mounting apertures of said first mounting ring being staggered with respect to said mounting apertures of said second mounting ring, said mounting apertures being disposed at a common radial position to define a circular pattern.

15. A method for fabricating a spring element for use in a load share gear comprising the steps of:
a) forming a pair of discs having a predefined thickness;
b) machining each disc to form a peripheral ring projecting orthogonally from a side thereof;
c) welding said peripheral rings of each together thereby forming a thin diaphragm structure, and
d) removing material from each side of said diaphragm structure to form a plurality of recurved radial spokes.

16. The method for fabricating a spring element for use in a load share gear according to claim 15, wherein said radial spokes are formed by Wire Electro-Discharge Machining.

17. The method for fabricating a spring element for use in a load share gear according to claim 15, wherein said radial spokes are formed by abrasive waterjet machining.

18. The method for fabricating a spring element for use in a load share gear according to claim 15, wherein said radial spokes are formed by Electro-Chemical Machining.

19. The method for fabricating a spring element for use in a load share gear according to claim 15, wherein said radial spokes are formed by High Speed Machining.
